(19) United States
(12) Patent Application Publication
(10) Pub. No.: US 2001/0039619 A1
(43) Pub. Date: Nov. 8, 2001

(54) Speaker verification interface for secure transactions

(76) Inventors: Martine Lapere, Knokke-Heist (BE); Mario Houthooft, Melle (BE); Daniel Mouly, Bordeaux (FR); Frank Hoornaert, Bertem (BE)

Correspondence Address: BROMBERG & SUNSTEIN LLP, 125 SUMMER STREET, BOSTON, MA, 02110-1618, US

(21) Appl. No.: 09/775,900

(22) Filed: Feb. 2, 2001

Related U.S. Application Data
(60) Provisional application No. 60/179,974, filed on Feb. 3, 2000.

(51) Int. Cl. H04L 9/00

(52) U.S. Cl. 713/186; 705/75

(57) ABSTRACT

A secure authentication code is provided. A authentication code generator has an internal-key biometric input arrangement, for storing a password derived from the biometric input, and for generating a transaction code based on a transaction input, a biometric input, and the internal key. A personal key is derived based on the internal key and a biometric input, and transferring the personal key to a server in a secure initialization session. The authentication code generator is used to derive a transaction code for each transaction that is communicated to the server at the time when transaction parameters are transmitted to the server. At the server level, the transaction parameters and the personal key are used to generate a reference that is compared with the transaction code to authenticate the transaction.

### FIELD OF THE INVENTION

The invention generally relates to biometric verification systems, and more particularly, to a client/server speaker verification interface for secured transactions.

### BACKGROUND ART

For various reasons, it is often desirable that a computer network, or some services of a computer network, be accessible only to authenticated terminals and/or users. One approach to authentication uses a hardware token—a special physical key or smart card that is required to activate a remote terminal. However, there are numerous problems with using a hardware token. A user may perceive the token as inconveniently large or small, too heavy, too hard to use, too easy to misplace or forget. An alternative authentication arrangement uses a password or personal identification number (PIN) code, but these may be hard to remember, or, if written down, easily compromised. Moreover, many such arrangements may be unsuitable for a visually impaired or physically disabled person.

Biometric verification systems, in general, and speaker verification systems, in particular, determine the identity of a registered user based upon comparison of presumptively unique personal features of a person purporting to be a registered user with a previously stored template associated with the features of the registered user. In speaker verification systems, these features are extracted from speech. Biometric verification systems have the advantage that the comparison features, e.g., one's voice, do not have to be “carried” as with a hardware token, and are not “forgettable” as with a password or PIN code.

A typical speaker verification system may operate in a client/server network environment in which the client may perform initial training and verification preprocessing; however, the ultimate verification operation is performed by the server. Such server-based authentication is necessary because the security of the client cannot be trusted, an imposter terminal could possibly send a counterfeit “match” decision to the server.

### SUMMARY OF THE INVENTION

A representative embodiment of the present invention includes a method of providing a secure transaction key. A transaction key generator is provided having an internal-key biometric input arrangement, for storing a password derived from the biometric input, and for generating a transaction code based on a transaction input, a biometric input, and the internal key. A personal key is derived based on the internal key and a biometric input. The personal key is transferred to a server in a secure initialization session. The transaction key generator is used to derive a transaction code for each transaction that is communicated to the server at the time when transaction parameters are transmitted to the server. At the server level, the transaction parameters and the personal key are used to generate a reference that is compared with the transaction code to authenticate the transaction.

Another representative embodiment includes a method of providing a secure authentication code from a network client to a network server. A user is prompted to provide a biometric input. An encrypted biometric token representative of a biometric input from an authorized user is decrypted. The biometric input is correlated with the decrypted biometric token. When the biometric input correlates to within a selected threshold of the decrypted biometric token, the biometric token is cryptographically transformed to generate an authorization token. The authorization token is processed to generate an encrypted authorization code, and the encrypted authorization code is forwarded to the network server.

In a further embodiment, the biometric input may be a spoken phrase, and the biometric token may be a representation of the spoken phrase from an authorized user. The biometric token may be encrypted and decrypted with a cryptographic key representing selected bits of a larger Data Encryption Standard (DES) key. Cryptographically transforming the biometric token may include processing the biometric token with a first transforming key representing selected bits of the DES key to produce a first intermediate token; processing the first intermediate token with a second transforming key representing selected bits of the DES key to produce a second intermediate token, the second transforming key being different from the first transforming key; and processing the second intermediate token with the first transforming key to produce the authorization token. Correlating the biometric input with the decrypted biometric token may include adding reverb to the biometric input and the decrypted biometric token.

### BRIEF DESCRIPTION OF THE DRAWINGS

The present invention will be more readily understood by reference to the following detailed description taken with the accompanying drawings, in which:

FIG. 1 illustrates logical steps in initializing a remote terminal for use with a representative embodiment of the present invention.

FIG. 2 illustrates logical steps in using a representative embodiment to generate a secure transaction authentication code.

### DETAILED DESCRIPTION OF SPECIFIC EMBODIMENTS

Representative embodiments of the present invention generate and provide a secure authentication code in a client/server environment, where the authentication code is generated by the remote client rather than by the server. This arrangement is useful, for example, in applications such as remote banking from a home personal computer, where the home personal computer acts as the remote client that generates and provides a secure authentication code. Representative embodiments are based on a biometric input arrangement, for example, a speaker verification system, using encryption techniques.

Operation of representative embodiments is divisible into an initialization phase and an operational phase. In the initialization phase, the authentication code system is installed on a remote client and registered with the server. In the operational phase, the client allows a registered user to be authenticated and an encrypted authentication code to be generated and provided to the server.

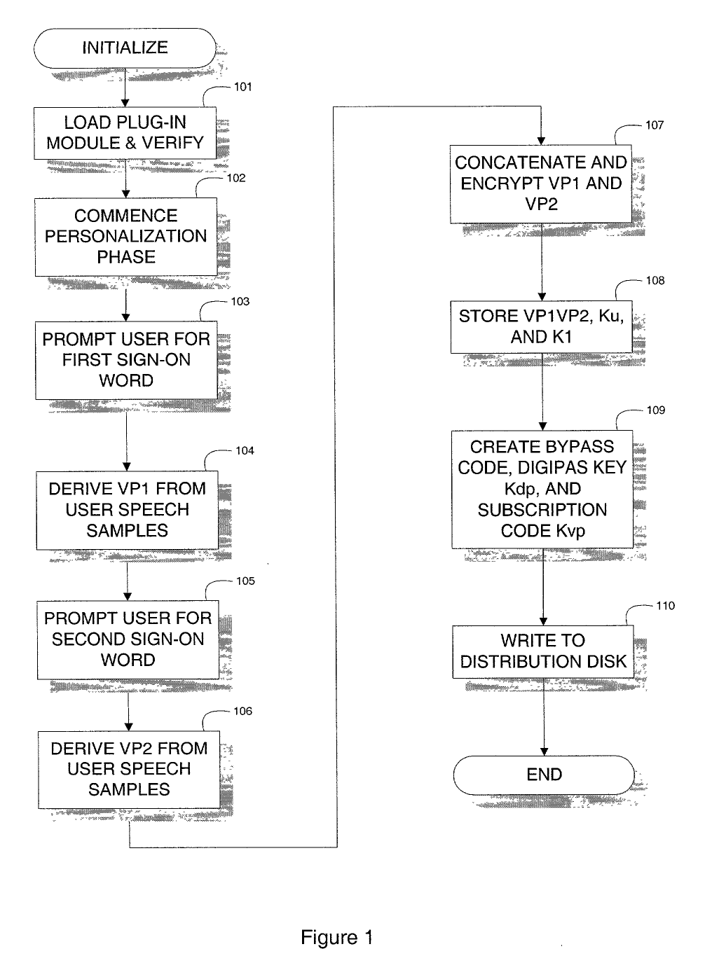

FIG. 1 shows the logical flow of initializing the system on a remote terminal according to an exemplary embodiment. First, in step 101, a software plug-in module is initially loaded and verified by a remote client such a personal computer in a user's home. The plug-in may be a piece of standard volume-distributed software without any secret information or secure keys. Unaltered code is assured by a secure checksum verification procedure that may or may not be encrypted. Upon verification, a personalization phase commences, step 102, from a distribution media, e.g., floppy disk or CD-ROM, personalized to the user and containing a “load” program, a personal triple DES 128-bit key K1, an unlock key Ku, a triple DES engine, and a conversion algorithm with a one-time key specific to the user.

The personalization phase initially prompts the registering user for a first sign-on word, step 103. The first sign-on word may be required to have a pre-specified length, but, in various embodiments may otherwise be either specified by the system, or left to the user to choose, perhaps with system guidance as to length, required sounds, etc. A first voiceprint VP1 is then derived from samples of user-provided speech responsive to the prompting, step 104. A voiceprint is a characteristic parameter representative of the speech pattern formed by the user speaking the sign-on word, typically modeled as a multi-dimensional vector. A voiceprint is not a stable parameter, but comparing two voiceprints of the same word for the same speaker will correlate together relatively closely. In a similar manner, a second sign-on word is then provided, step 105, and a second voiceprint generated, step 106.

When both voiceprints VP1 and VP2 are generated, they are concatenated and encrypted, step 107. The length of the voiceprints VP1 and VP2 can vary, for example, from 330 bytes to 2 Kbytes, and the concatenation of the voiceprints will also vary in length, as will the voiceprint produced during subsequent log-on attempts. Thus, the voiceprints themselves are not suitable for encryption/decryption keys. Encrypting the voiceprints may be based on selecting a key K1C from 56 pseudo-random bits of a personal DES key K1. Each voiceprint, VP1 and VP2, would then be encrypted with the encryption key K1C.

The encrypted voiceprints and a concatenation signature are stored on the remote terminal, along with an unlock key Ku and the personal DES key K1, step 108. In some embodiments, the unlock key Ku and the personal DES key K1 may preferably be stored in their encrypted format in a separate physical location from the encrypted voiceprints VP1 and VP2. Such an arrangement may provide some protection against later having the decrypted keys loaded into the remote terminal memory at a time when only the voiceprints are required for checking a log-in voiceprint. To avoid having the encryption key K1C being stored in the remote terminal memory in unencrypted form, it may be XOR'd with a like number of bits of the encrypted voiceprints, and then stored. When the encryption key K1C is subsequently required by the system, the stored key may be XOR'd with the same bits of the encrypted voiceprints to obtain the original encryption key K1C.

Voiceprints VP1 and VP2 are also used to create a bypass code (explained later), an authorization encryption key Kdp, and an authentication key Kvp (which is sent to a network server), step 109. Fifty-six pseudo-random bits of the encrypted voiceprints may be selected to form the authentication key Kvp. Then, XOR-ing the encryption key K1C with the authentication key Kvp produces an encrypted version of the encryption key K1C suitable for storage on the remote terminal. The encryption key K1C and/or the encrypted voiceprints VP1 and VP2 may also be used to encrypt and store the triple-DES key K1 on the remote terminal. Once the system is properly initialized on the remote terminal, the various keys on the distribution disk are written over, step 110.

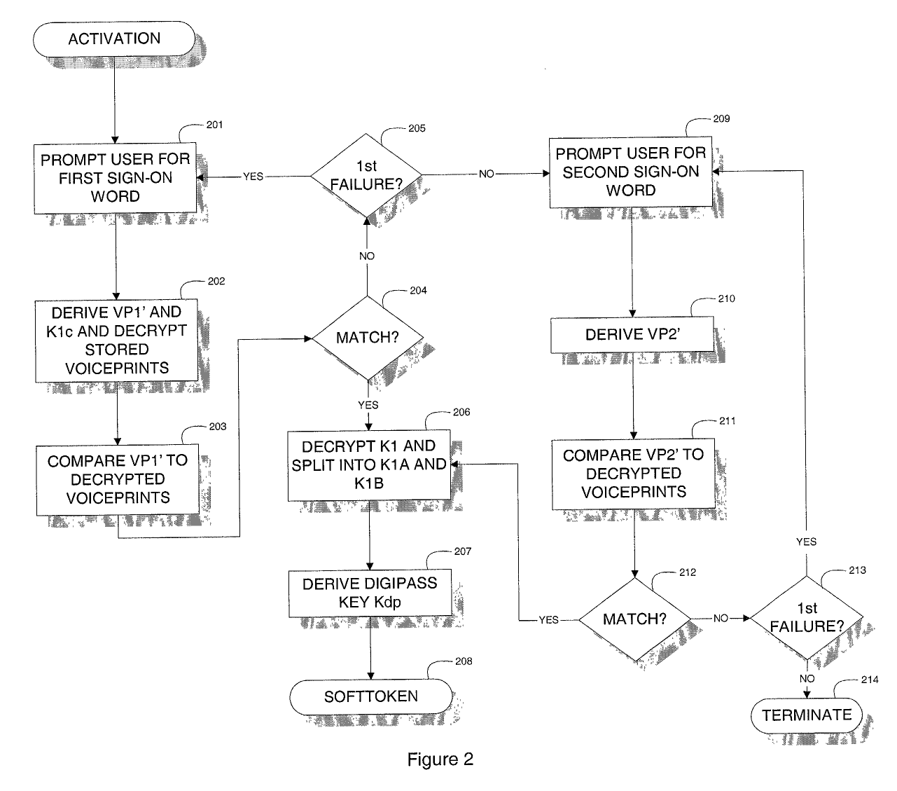

In the operational phase, represented by FIG. 2, the system prompts an unverified user for a first sign-on word, step 201. From the user's response, a first input voiceprint VP1′ is derived; voiceprint encryption key K1C also is derived and used to decrypt the stored registered voiceprints VP1 and VP2, step 202. The input voiceprint VP1′ then is correlated with the decrypted voiceprint VP1, step 203. In a complex or difficult acoustic environment, various signal processing techniques may be employed in step 203. For example, adding some reverb to the input voiceprint VP1′ and comparing it to a reverb version of VP1 may be advantageous. If, in step 203, the correlation is within a preselected threshold, the voiceprints are considered to match, step 204. Assuming a match, the DES key K1 is decrypted using the decrypted stored voiceprints, and split into keys K1A and K1B, step 206. The decrypted concatenated voiceprints VP1VP2 are sequentially processed by the keys K1A and K1B to derive authorization encryption key Kdp, step 207, which in turn is used to generate an authentication code, step 208.

If in step 204, VP1′ does not correlate to VP1 within the preselected threshold, the system then considers if this is the first failure of the two to match, step 205. If it is the first time that the two voiceprints failed to match, then steps 201, 202, 203, and 204 are repeated. If, in step 205, the failure to match in step 204 was the second such failure, then the user is prompted for a second sign-on word, step 209. As before, from the user's response, a second input voiceprint VP2′ is derived, step 210, and correlated with the decrypted voiceprint VP2, step 211. As with the earlier correlation of VP1′ and VP1 in step 203, in complex or difficult acoustic environments the correlation of the second input voiceprint VP2′ with decrypted voiceprint VP2 in step 211 may benefit from various signal processing techniques such as adding reverb. If the correlation is within the preselected threshold, they are considered to match, step 212, and, assuming a match, steps 206, 207, and 208 are performed as previously described to generate an authentication code. If VP2 and VP2′ do not match in step 212, then the system considers if this the first time they have failed to match, step 213. If it is the first failure, steps 209-212 are repeated for a second time. The second time that VP2 and VP2′ fail to match in step 213, the system terminates.

Various alternative arrangements may be made to handle the case, in step 213, for when the voiceprints do not match after four tries. Such alternatives include locking the system against further action, showing an unlock challenge, and requesting a bypass code. Locking the system can be achieved by partial or complete erasure of the authentication code. This approach requires the bona fide user to obtain a new distribution plug-in with a new DES key K1 and different sign-on words. The unlock challenge approach allows a network owner to enable remote unlocking. In such a case, the locked-out user calls a help-desk number and follows a pre-defined routine to identify the user as the correct registered user. The help-desk may then provide a one-time 6 or 8 alphanumeric digit unlock code that the user inputs in response to the unlock challenge at the remote terminal. A pre-arranged bypass code may also be employed in which, following the fourth failure, the bypass code is entered by the user to unlock his token; typically, use of such a bypass procedure would be logged by the system.

Preferred embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of providing a secure transaction key, the method comprising:
a. providing a transaction key generator having an internal-key biometric input arrangement, for storing a password derived from the biometric input, and for generating a transaction code based on a transaction input, a biometric input, and the internal key;
b. deriving a personal key based on the internal key and a biometric input, and transferring the personal key to a server in a secure initialization session;
c. using the transaction key generator to derive a transaction code for each transaction that is communicated to the server at the time when transaction parameters are transmitted to the server;
d. at the server level, using the transaction parameters and the personal key to generate a reference that is compared with the transaction code to authenticate the transaction.

2. A method of providing a secure authentication code from a network client to a network server, the method comprising:
prompting a user to provide a biometric input;
decrypting an encrypted biometric token representative of a biometric input from an authorized user;
correlating the biometric input with the decrypted biometric token and, when the biometric input correlates to within a selected threshold of the decrypted biometric token, cryptographically transforming the biometric token to generate an authorization token;
processing the authorization token to generate an encrypted authorization code; and
forwarding the encrypted authorization code to the network server.

3. A method according to claim 2, wherein the biometric input is a spoken phrase, and the biometric token is a representation of the spoken phrase from an authorized user.

4. A method according to claim 2, wherein the biometric token is encrypted and decrypted with a cryptographic key representing selected bits of a larger Data Encryption Standard (DES) key.

5. A method according to claim 4, wherein cryptographically transforming the biometric token includes:
processing the biometric token with a first transforming key representing selected bits of the DES key to produce a first intermediate token;
processing the first intermediate token with a second transforming key representing selected bits of the DES key to produce a second intermediate token, the second transforming key being different from the first transforming key; and
processing the second intermediate token with the first transforming key to produce the authorization token.

6. A method according to claim 2, wherein correlating the biometric input with the decrypted biometric token includes adding reverb to the biometric input and the decrypted biometric token.
